(19) United States
(12) Patent Application Publication
(10) Pub. No.: US 2024/0330218 A1
(43) Pub. Date: Oct. 3, 2024

(54) NETWORK INTERFACE DEVICE AS A CROSS-DOMAIN SOLUTION (CDS)

(71) Applicant: Intel Corporation, Santa Clara, CA (US)

(72) Inventors: Akhilesh S. THYAGATURU, Ruskin, FL (US); Stanley MO, Portland, OR (US); Jason M. HOWARD, Portland, OR (US); Sanjaya TAYAL, Portland, OR (US); Nicholas ROSS, Lake Forest, CA (US)

(21) Appl. No.: 18/660,144

(22) Filed: May 9, 2024

(51) Int. Cl. G06F 13/28

(52) U.S. Cl. CPC G06F 13/28; G06F 2213/28

(57) ABSTRACT

Examples described herein relate to a network interface device that includes a direct memory access (DMA) circuitry; a network interface; at least two host interfaces to simultaneously connect to multiple platforms; an interface to a memory device; and circuitry. In some examples, at least two of the multiple platforms include a processor and a memory coupled to a circuit board. In some examples, the circuitry is to: based on a level of security classification of a second platform of the multiple platforms, perform secure transfer of data from a first platform of the multiple platforms to the second platform of the multiple platforms and enforce rules for data access and data transfer by the multiple platforms.

### BACKGROUND

In computing, the lack of or insufficiency of security measures could leave applications vulnerable to cyber-attacks and unauthorized data access. A cross-domain solution (CDS) is an integrated system that facilitates the secure exchange of information between two or more security domains with different security classifications or levels of trust.

### BRIEF DESCRIPTION OF THE DRAWINGS

FIG. 1 depicts an example system.

FIG. 2 depicts an example firewall table.

FIG. 3 depicts an example of a rule in a permission table.

FIG. 4 depicts an example of transfer of data between servers.

FIGS. 5A and 5B depict example processes.

FIG. 6 depicts an example network interface device.

FIG. 7 depicts an example network interface device.

FIG. 8 depicts an example system.

### DETAILED DESCRIPTION

CDS plays a crucial role in safeguarding sensitive data across various critical sectors, from the high-speed world of automotive engineering to the delicate balance of healthcare information. CDS empowers secure data exchange in a variety of domains. For instance, CDS may benefit automotive applications, such as connected cars, which may assume vehicles exchanging real-time traffic data, safety alerts, and even software updates across different manufacturers and infrastructure providers. CDS ensures secure communication between these disparate systems, preventing unauthorized access and protecting critical driving data and functions. In autonomous driving applications, as self-driving cars become mainstream, CDS may be invaluable for securing communication between sensors, onboard computers, and external infrastructure like traffic lights and V2X (vehicle-to-everything) networks.

CDS may also be employed within financial applications, such as secure data sharing. CDS facilitates secure data exchange between banks, credit bureaus, and other financial institutions, enabling faster loan approvals, better risk assessments, and improved customer service. CDS may be beneficial within healthcare applications. For instance, CDS may be advantageously applied in maintaining patient data privacy. CDS helps to decouple the data in the healthcare providers and securely share patent data between hospitals, clinics, and pharmacies while complying with strict privacy regulations such as the Health Insurance Portability and Accountability Act (HIPAA). This ensures technology used in facilitating patent care also protects sensitive medical information. CDS may also be employed within telemedicine and remote monitoring by enabling secure communication between doctors and patents during telemedicine consultations and allows for real-time data transfer from medical devices worn by patients remotely. Furthermore, CDS safeguards data in critical infrastructure like power grids, communication networks, and transportation systems against cyberattacks and unauthorized access.

In some examples, a network interface device can implement a CDS, which operates independently of the computing hardware utilized to implement trusted and untrusted domains in which various applications, services, and microservices may be run. In some implementations, a network interface device provides an interface that implements a secure gateway between domains, enforcing specific rules for data access and transfer such that only authorized information flows in the right direction and at the right level of classification (e.g., to maintain the higher requirements and more demanding rules of the higher security domain). This could involve transferring files, streaming data, or even running interoperating applications across different security levels.

For example, by isolating domains and controlling data flow, the network interface device can mitigate the risk of unauthorized data access, data breaches, and malware infections. The network interface device may also enforce security rules so that the CDS operates based on pre-defined security rules that dictate how data can be accessed, transferred, and sanitized. These rules can ensure compliance with regulations and organizational security best practices (e.g., and requirements of the higher-trust domain coupled to the CDS).

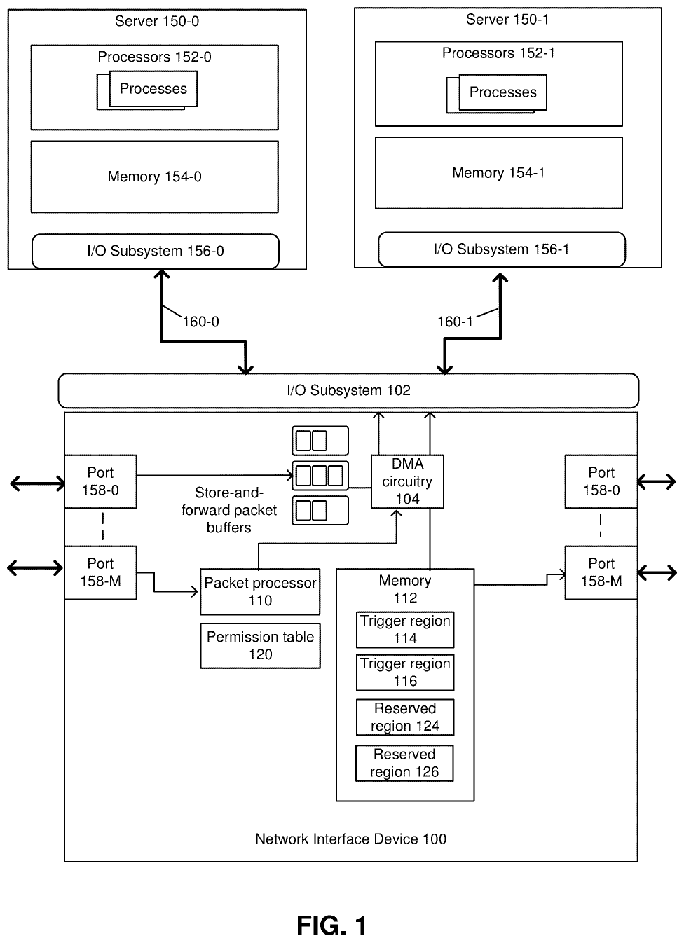

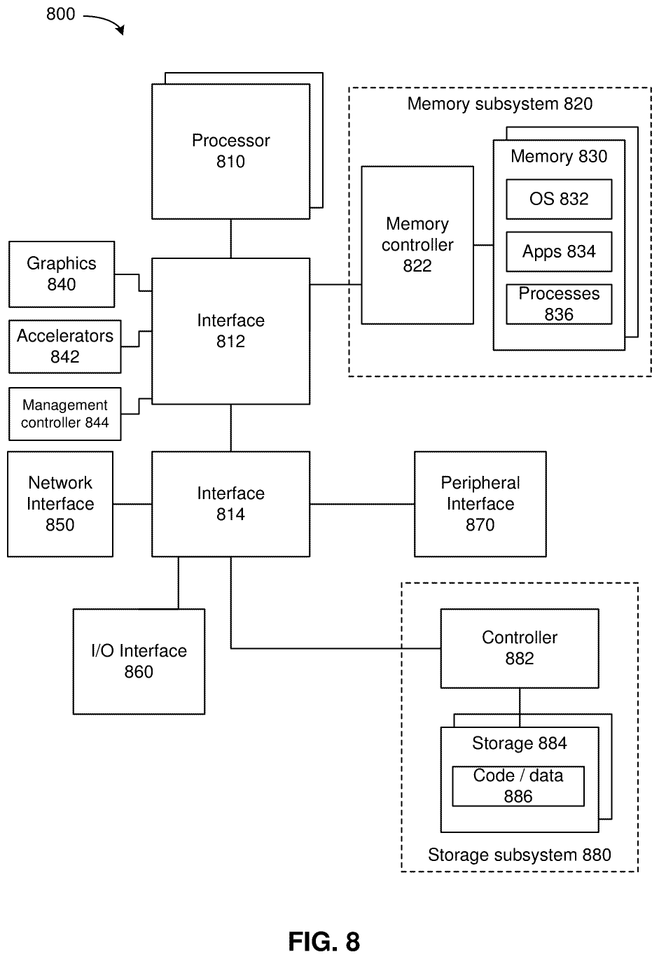

FIG. 1 depicts an example system. One or more of servers 150-0 and 150-1 can include circuitry and/or software described at least with respect to FIG. 8. Processors 152-0 and 152-1 can include one or more of: a central processing unit (CPU); a programmable packet processing circuitry; an accelerator; an application specific integrated circuit (ASIC); a field programmable gate array (FPGA); a graphics processing unit (GPU); a memory device; or other circuitry. One or more processors 152-0 and 152-1 can execute one or more of: processes, a driver, and an operating system (OS). Processes can include one or more of: an application, a microservice, virtual machine (VM), microVM, container, thread, or other virtualized execution environment. Processes can perform network functions that include: 5G core, service function chaining, network function virtualization, Industrial Control System loops, or others.

For example, a process can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtual execution environments (e.g., VMs or containers). VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

One or more of servers 150-0 and 150-1 can be communicatively coupled to I/O subsystem 102 of network interface device 100 by respective host interfaces 156-0 and 156-1. Host interfaces 156-0 and 156-1 can provide communication using one or more of the following protocols: Inter-Integrated Circuit (I2C), Improved Inter-Integrated Circuit (I3C), Universal Serial Bus Type (USB), serial peripheral interface (SPI), enhanced SPI (eSPI), System Management Bus (SMBus), MIPI I3C®, Peripheral Component Interconnect Express (PCIe), Compute Express Link (CXL), double data rate (DDR), CXL.mem to allow direct byte-addressable access to remote memory of network interface device 100, or other custom protocol. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. In some examples, server 150-0 and 150-1 can communicate using network protocols (e.g., TCP/IP) on either side of host domains, possibly applying encrypted communications such as IPSec.

Network interface device 100 can be implemented as one or more of: a network interface controller (NIC), a remote direct memory access (RDMA)-enabled NIC, SmartNIC, router, switch, virtual switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized Radio Access Networks (vRANs), cryptographic operations, compression/decompression, and so forth).

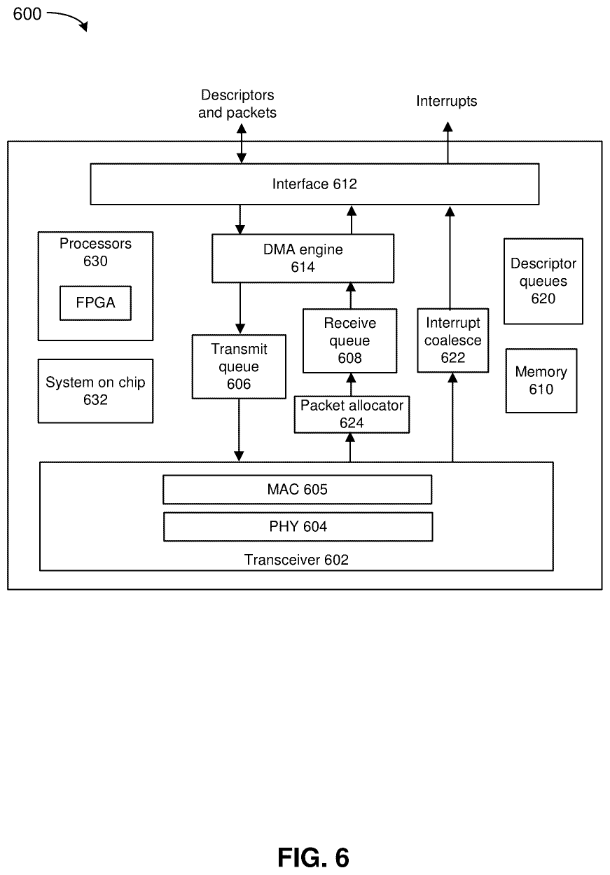

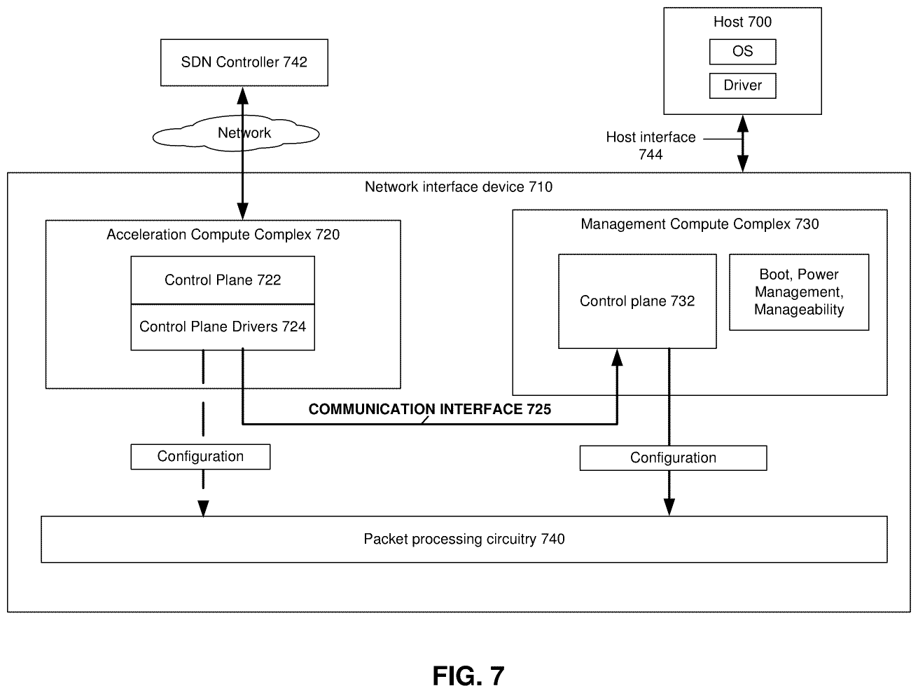

Network interface device 100 can include at least a direct memory access (DMA) circuitry 104, packet processing circuitry 110, as well as other circuitry and software described with respect to FIGS. 6, 7, and/or 8. Network interface device 150 can utilize one or more of bi-directional ports 158-0 to 158-M (where M is an integer) to receive packets (at ingress) or transmit packets (at egress).

Servers in different trust domains can transfer data to one another securely using network interface device 100 as a CDS. Network interface device 100 can utilize packet processing circuitry 110 to provide a CDS for transfers of data from a trusted domain of server 150-0 to a trusted domain of server 150-1 and for transfers of data from a trusted domain of server 150-1 to a trusted domain of server 150-0. In addition, network interface device 100 can utilize packet processing circuitry 110 to provide a CDS to gate or block: transfers of data from an untrusted domain of server 150-0 to a trusted domain of server 150-1, transfers of data from an untrusted domain of server 150-1 to a trusted domain of server 150-0, transfers of data from a trusted domain of server 150-0 to an untrusted domain of server 150-1, and/or for transfers of data from a trusted domain of server 150-1 to an untrusted domain of server 150-0.

CDS can be implemented as a confidential computing environment or secure enclave. The confidential computing environment or secure enclave can be created using one or more of: total memory encryption (TME), multi-key total memory encryption (MKTME), Trusted Domain Extensions (TDX), Double Data Rate (DDR) encryption, function as a service (FaaS) container encryption or an enclave/TD (trust domain), Intel® SGX, Intel® TDX, AMD Memory Encryption Technology, AMD Secure Memory Encryption (SME) and Secure Encrypted Virtualization (SEV), AMD Secure Encrypted Virtualization-Secure Nested Paging (AMD SEV-SNP), ARM® TrustZone®, ARM® Realms and Confidential Compute, Apple Secure Enclave Processor, Qualcomm® Trusted Execution Environment, Distributed Management Task Force (DMTF) Security Protocol and Data Model (SPDM) specification, virtualization-based isolation such as Intel VTd and AMD-v, or others.

While examples depict two servers utilizing network interface device 100 as a CDS, more than two servers can utilize network interface device 100 as a CDS. In some examples, a server (not shown) can communicate with network interface device 100 using Ethernet packets and network interface device 100 can provide a CDS to transfer data to server 150-0 and/or 150-1. In some examples, network interface device 100 can provide a CDS to transfer data from server 150-0 or 150-1 to a server (not shown) using Ethernet packets. In some examples, data can be transferred by multi-cast, or sent to multiple different destination servers, instead of merely one server. Transfers of data can include sending data through a push method (e.g., sending data without a prior request), or requesting data through a pull method.

To provide a CDS, network interface device 100 can permit memory-to-memory transfers between at least memory 154-0 of server 150-0 and memory 154-1 of server 150-1. For example, an orchestrator or data center administrator can allocate one or more addressable regions 124 in memory 112 for server 150-0 to write or read data and allocate one or more addressable regions 126 in memory 112 for server 150-1 to write or read data. Moreover, an orchestrator or data center administrator can allocate one or more addressable regions in memory 112 as trigger region 114 for server 150-0. Similarly, an orchestrator or data center administrator can allocate one or more addressable regions 116 in memory 112 as a trigger region for server 150-1.

In some examples, memory 112 can be implemented as a memory integrated into a system on chip of the network interface device 100 or can be connected by a device interface (e.g., PCIe, CXL, or DDR) to network interface device 100.

For example, to initiate a transaction from memory 154-0 of server 150-0 to memory 154-1 of server 150-1, server 150-0 can write data into region 124 and identify data, length of data, and address of data in trigger region 114 to identify data, length of data, and address of data that network interface device 100 is to copy to server 150-1, if the transaction is permitted. For example, by writing to trigger region 114, server 150-0 can cause packet processing circuitry 110 to verify whether a transfer of data from server 150-0 to 150-1 is permitted. To verify whether a transfer of data from server 150-0 to 150-1 is permitted, packet processing circuitry 110 can access permission table 120, described herein. Based on verification of the transaction, network interface device 150 can copy the data using direct memory access (DMA) circuitry 104 to memory 154-1.

Similarly, to initiate a transaction from memory 154-1 of server 150-1 to memory 154-0 of server 150-0, server 150-1 can write data into region 126 and identify data, length of data, and address of data in trigger region 116 to identify data, length of data, and address of data that network interface device 100 is to copy to server 150-0, if the transaction is permitted. For example, by writing to trigger region 116, server 150-1 can cause packet processing circuitry 110 to verify whether a transfer of data from server 150-1 to 150-0 is permitted. To verify whether a transfer of data from server 150-1 to 150-0 is permitted, packet processing circuitry 110 can access permission table 120, described herein. Based on verification of the transaction, network interface device 150 can copy the data using DMA circuitry 104 to memory 154-0.

In some examples, packet processing circuitry 110 can cause transfer of encrypted data from memory 154-0 of server 150-0 to memory 154-1 of server 150-1 while also providing security keys for the encrypted data to server 150-1 to decrypt the data. In some examples, packet processing circuitry 110 can cause transfer of encrypted data from memory 154-0 of server 150-0 to memory 154-1 of server 150-1 and server 150-1 can utilize keys stored in server 150-1 to decrypt the end-to-end encrypted data.

In some examples, packet processing circuitry 110 can cause transfer of encrypted data from memory 154-1 of server 150-1 to memory 154-0 of server 150-0 and also provide security keys for the encrypted data to server 150-0 to decrypt the data. In some examples, packet processing circuitry 110 can cause transfer of encrypted data from memory 154-1 of server 150-1 to memory 154-0 of server 150-0 and server 150-0 can utilize keys stored in server 150-0 to decrypt the end-to-end encrypted data.

In some examples, packet processing circuitry 110 can execute a web service that establishes user/node level access and transport level security (TLS) by applying data packet level security. Packets coming from an authenticated node/service could be signed and this signature/credential would be confirmed in permission table 120, which would allow or deny the packet access to the webservice.

In some examples, packets routed through network interface device 100 to an umbrella web service could be read and the packets automatically routed to the correct secured web service. By doing this, secured web services would not be named and exposed to other non-secured web services and systems. The encoding in the packet routed to the meta web service could allow the packets to be delivered so that the sending webservice would not necessarily have to be a secured domain itself, as an application or the data could be used to provide the correct packet encoding for routing to the meta-service and the packet's encoded header could be read by packet processing circuitry 110 and using permission table 120 to automatically route the data.

In some examples, based on a level of security classification of receive server being lower than a level of security classification of a sender, packet processing circuitry 110 can permit transfer of non-confidential data to the receiver server.

In some examples, to receive updates about memory transactions and other events, server 150-0 can poll trigger space 114 to read trigger values (e.g., an operation code) that trigger pre-defined actions. In some examples, when server 150-1 or another device writes a specific value to trigger region 114, network interface device 100 can send a notification to server 150-0 to alert server 150-0 about the event, using a network or device interface. However, based on the specific value or command written to trigger region 114, network interface device 100 can perform additional operations on data such as one or more of: encryption, decryption, compression, decompression, validation (e.g., checksum verification), or others.

In some examples, where processors 152-0 of server 150-0 are in a sleep state, packet processing circuitry 110 can execute a MONITOR instruction to monitor an address in trigger region 114 on which to wait for a change in value and execute an instruction that causes the wait operation to commence (MWAIT). Based on detection of a write to trigger space 114, packet processing circuitry 110 can cause processor 152-0 of server 150-0 to wake up and request packet processing circuitry 110 to cause transfer of associated data from memory 112 to memory 154-0 of server 150-0, if the transfer is permitted by permission table 120.

In some examples, where processor 152-1 of server 150-1 is in a sleep state, packet processing circuitry 110 can execute a MONITOR instruction to monitor an address in trigger space 114 on which to wait for a change in value and execute an instruction that causes the wait operation to commence (MWAIT). Based on detection of a write to trigger space 114, packet processing circuitry 110 can cause processor 152-1 of server 150-1 to wake up and request packet processing circuitry 110 to cause transfer of associated data from memory 112 to memory 154-1 of server 150-1, if the transfer is permitted by permission table 120.

Based on permission table 120, packet processing circuitry 110 can be configured by an orchestrator or data center administrator to perform an address based filtering of a requester identifier or address, organized similarly to virtual memory page tables and process-credential permission checks that provide data-diode isolation.

Based on configurations in permission table 120, packet processing circuitry 110 can perform network operations of a firewall, a virtual switch such as Open Virtual Switch (OVS), Intrusion Detection System (IDS), or Intrusion Prevention System (IPS), or other network functions.

In addition, to providing a CDS between servers 150-0 and 150-1, network interface device 100 can provide a CDS for packets received from a local area network (LAN) such as Ethernet packets. Based on the defined rules in permission table 120, packet processing circuitry 110 can implement a firewall to allow or block packet forwarding. Packets violating protocol format, missing proper authorization, or exceeding access control parameters are automatically blocked or sent to a host to perform exception handling.

CDS can offer application programming interfaces (APIs) or scripting tools to allow programmatically building and interpreting data structures (e.g., data types, field lengths, and delimiters for structuring messages). CDS can utilize user specific encryption libraries or implement custom key exchange protocols within the CDS framework. CDS can perform token-based systems, password verification methods, or role-based access controls within the CDS architecture.

The Linux kernel memmap-nn [KMG] $ss [KMG] parameter with a value of memmap=16G$128G can be set to mark 16 GB of memory of network interface device 100 as a reserved region after 128 GB.

After reboot, a server executed process can access the reserved memory using/dev/mem and a mmap command. The following code can be compiled for execution to access a reserved region in memory of a network interface device.

fd = open(“/dev/mem”, O_RDWR | O_SYNC);
map_base = mmap(0, size , PROT_READ | PROT_WRITE,
MAP_SHARED, fd, target & ~MAP_MASK;

While examples describe network interface device 100 as a CDS, in some examples, in addition, or alternatively, CDS can be implemented using an accelerator (e.g., FPGA), GPU, an I/O device, memory, memory controller (e.g., CXL controller), or CPU and memory.

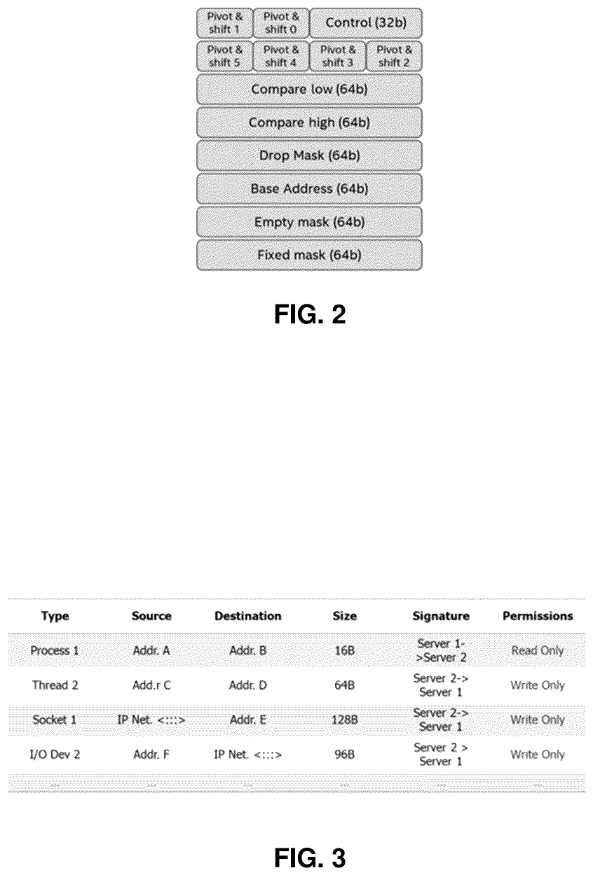

FIG. 2 depicts an example firewall table. A firewall table (e.g., credential or permission table) can be specified per host link (e.g., 156-0 and 156-1) to network interface device 100. However, in some examples, the firewall table can specify restrictions per process (e.g., process address space identifier (PASID) value) or device (e.g., Resource Monitoring IDs (RMIDs)). The firewall table can restrict access to certain addressable memory regions in memory of the network interface device to only be accessible by the link or requester. An orchestrator or data center administrator can program permission rules to allow access for certain address ranges for a link, while preventing access to other address ranges. Specifically, the following rules may be utilized: reject-all, reject-read, reject-write, allow-all, allow-read, or allow-write. In some examples, packet processing circuitry or other circuitry of a network interface device can check rules sequentially, giving priority to rules checked earlier, so that multiple rules can be applied.

Control can indicate a permission rule (e.g., reject-all, reject-read, reject-write, allow-all, allow-read, or allow-write) for a range of memory addresses and an enable/disable bit can indicate the rule is enabled or disabled. Comparing high and compare low fields can include upper and lower memory address ranges that associated with the control. Fields Drop Mask, Base Address, Empty mask, Fixed mask, and Pivot & Shift can be used in address translation from one address space to another address space.

FIG. 3 depicts an example of permission table entries to control flow of data between servers. A permission table of one or more rules can restrict access of contents of memory addresses, by a requester, in a network interface device applicable to a range of addresses between Compare Low and Compare High. For example, process 1 executed by server 2 can merely read a 16Byte size of data starting at memory address A and copy the data to a memory address starting at memory address B. For example, Thread 2 executed by server 1 can merely write a 64Byte size of data from memory address C to memory address D. For example, socket 1 on server 1 and identified by a particular Internet Protocol (IP) address can merely write a 128Byte size of data to memory address E. For example, I/O device 2 on server 1 can merely read a 96Byte size of data from memory address F and store the data to a particular IP address.

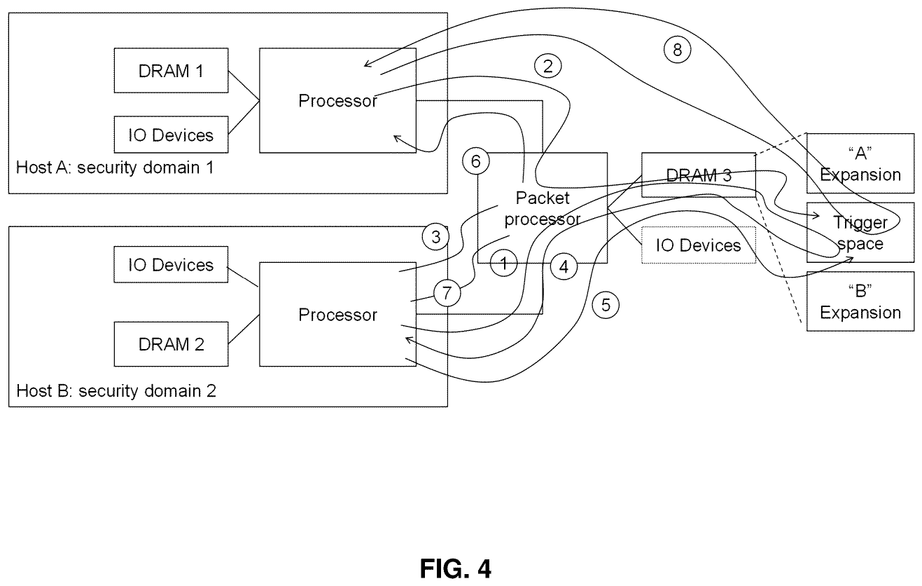

FIG. 4 depicts an example of transfer of data between servers. At (1), a processor of host B is in a sleep/wait state. At (2), a processor of host A writes data to the network interface device memory and goes into a sleep/wait state. At (3), the processor of host B wakes up based on a change to trigger space. At (4), the processor of host B reads the data from the network interface device memory and stores the data into memory of host B. At (5), the processor of host B processes the data and writes processed data into network interface device memory. At (6), the processor of host A wakes up from sleep/wait state. At (7), the processor of host B returns to sleep/wait state. At (8), the processor of host A reads the processed data from the network interface device memory. Note that one or more of operations (1)-(8) can be combined.

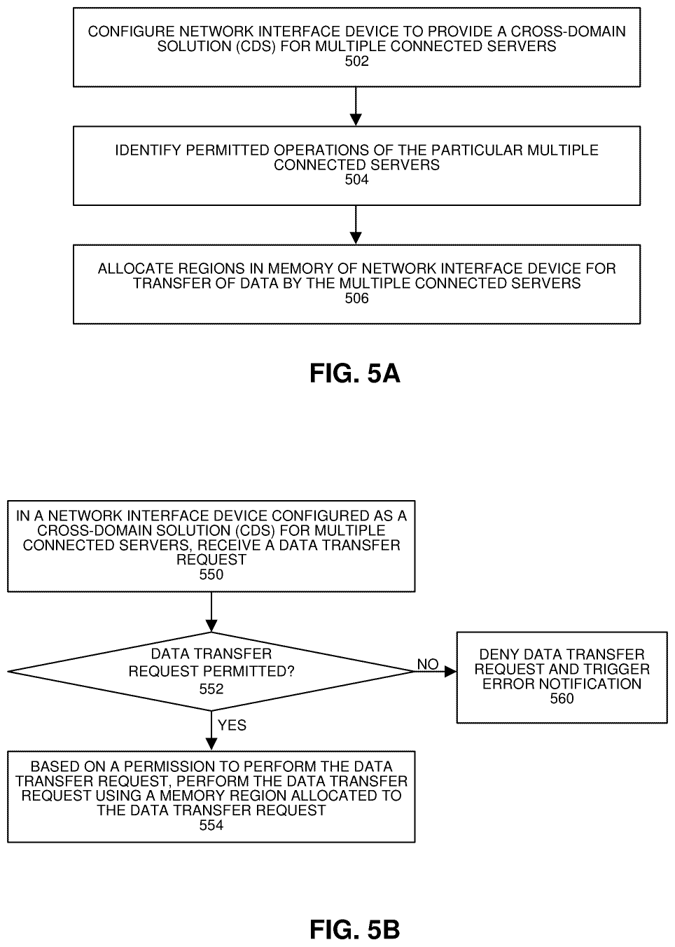

FIG. 5A depicts an example process. The process can be performed by an orchestrator. At 502, a network interface device can be configured as a CDS for multiple connected servers. The servers can be connected by a device interface, network (e.g., Ethernet packets), or other interface. At 504, the network interface device can be configured with permitted memory transfer operations that access memory of the network interface device. At 506, the memory of the network interface device can be configured so that memory transfer operations and data associated with memory transfer operations are stored in particular regions of the memory.

FIG. 5B depicts an example process. The process can be performed by a network interface device. At 550, the network interface device configured as a CDS for multiple connected servers can receive a data transfer request. At 552, based on a permission table that identifies memory transfer operations permitted to access memory of the network interface device, a determination can be made as to whether the received memory transfer operation is permitted. At 554, based on the received memory transfer operation being permitted, the process can proceed to copy the memory transfer operation and data to particular regions of memory of the network interface device specified in the configuration. At 560, the memory transfer operation can be denied and an exception message can be indicated to the host server that was targeted to process the memory transfer operation. For example, the memory transfer operation can be associated with a malicious attack and this notification can be used to inform a host system of unauthorized access requests.

FIG. 6 depicts an example network interface device. In some examples, processors 430, system on chip 432, and memory 610 can be configured for use in a CDS, as described herein. Some examples of network interface 600 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable circuitries or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 600 can include transceiver 602, processors 630, transmit queue 606, receive queue 608, memory 610, and host interface 612, and DMA engine 614. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 604 and media access control (MAC) circuitry 605. PHY circuitry 604 can include encoding and decoding circuitry (not shown) to encode and decode data packets according to applicable physical layer specifications or standards. MAC circuitry 605 can be configured to perform MAC address filtering on received packets, process MAC headers of received packets by verifying data integrity, remove preambles and padding, and provide packet content for processing by higher layers. MAC circuitry 605 can be configured to assemble data to be transmitted into packets, that include destination and source addresses along with network control information and error detection hash values.

Processors 630 can be one or more of: combination of: a processor, core, graphics processing unit (GPU), field programmable gate array (FPGA), application specific integrated circuit (ASIC), or other programmable hardware device that allow programming of network interface 600. For example, a “smart network interface” or SmartNIC can provide packet processing capabilities in the network interface using processors 630.

Processors 630 can include a programmable processing pipeline or offload circuitries that is programmable by P4, Software for Open Networking in the Cloud (SONIC), Broadcom® Network Programming Language (NPL), NVIDIA® CUDA®, NVIDIA® DOCATM, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be utilized for packet processing or packet modification. Ternary content-addressable memory (TCAM) can be used for parallel match-action or look-up operations on packet header content. Processors 630 can be configured to permit or deny memory transfer requests, as described herein.

Packet allocator 624 can provide distribution of received packets for processing by multiple CPUs or cores using receive side scaling (RSS). When packet allocator 624 uses RSS, packet allocator 624 can calculate a hash or make another determination based on contents of a received packet to determine which CPU or core is to process a packet.

Interrupt coalesce 622 can perform interrupt moderation whereby interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into and network interface 600 provides this coalesced packet to a host system.

Direct memory access (DMA) engine 614 can copy a packet header, packet payload, and/or descriptor directly from host memory to the network interface or vice versa, instead of copying the packet to an intermediate buffer at the host and then using another copy operation from the intermediate buffer to the destination buffer.

Memory 610 can be volatile and/or non-volatile memory device and can store any queue or instructions used to program network interface 600. Transmit traffic manager can schedule transmission of packets from transmit queue 606. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Bus interface 612 can provide an interface with host device (not depicted). For example, bus interface 612 can be compatible with or based at least in part on PCI, PCIe, PCI-x, Serial ATA, and/or USB (although other interconnection standards may be used), or proprietary variations thereof.

FIG. 7 depicts an example network interface device. As described herein, packet processing device 710 can be configured as a CDS. Host 700 can include processors, memory devices, device interfaces, as well as other circuitry, such as those described herein. Processors of host 700 can execute software such as applications (e.g., microservices, virtual machine (VMs), microVMs, containers, processes, threads, or other virtualized execution environments), operating system (OS), and device drivers. An OS or device driver can configure network interface device or packet processing device 710 to utilize one or more control planes to communicate with software defined networking (SDN) controller 742 via a network to configure operation of the one or more control planes.

Packet processing device 710 can include multiple compute complexes, such as an Acceleration Compute Complex (ACC) 720 and Management Compute Complex (MCC) 730, as well as packet processing circuitry 740 and network interface technologies for communication with other devices via a network. ACC 720 can be implemented as one or more of: a microprocessor, processor, accelerator, field programmable gate array (FPGA), application specific integrated circuit (ASIC) or circuitry described at least with respect to herein. Similarly, MCC 730 can be implemented as one or more of: a microprocessor, processor, accelerator, field programmable gate array (FPGA), application specific integrated circuit (ASIC) or circuitry described herein. In some examples, ACC 720 and MCC 730 can be implemented as separate cores in a CPU, different cores in different CPUs, different processors in a same integrated circuit, different processors in different integrated circuit.

Packet processing device 710 can be implemented as one or more of: a microprocessor, processor, accelerator, field programmable gate array (FPGA), application specific integrated circuit (ASIC) or circuitry described herein. Packet processing circuitry 740 can process packets as directed or configured by one or more control planes executed by multiple compute complexes. In some examples, ACC 720 and MCC 730 can execute respective control planes 722 and 732.

Packet processing device 710, ACC 720, and/or MCC 730 can be configured to detect and report errors arising from processing packets, as described herein.

SDN controller 742 can upgrade or reconfigure software executing on ACC 720 (e.g., control plane 722 and/or control plane 732) through contents of packets received through packet processing device 710. In some examples, ACC 720 can execute control plane operating system (OS) (e.g., Linux) and/or a control plane application 722 (e.g., user space or kernel modules) used by SDN controller 742 to configure operation of packet processing circuitry 740. Control plane application 722 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 742 can communicate with ACC 720 using a remote procedure call (RPC) such as gRPC or other service and ACC 720 can convert the request to target specific Protocol Buffer (protobuf) request to MCC 730. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 742 can provide packet processing rules for performance by ACC 720. For example, ACC 720 can program table rules (e.g., header field match and corresponding action) applied by packet processing circuitry 740 based on change in policy and changes in VMs, containers, microservices, applications, or other processes. ACC 720 can be configured to provide network policy as flow cache rules into a table to configure operation of packet processing 740. For example, the ACC-executed control plane application 722 can configure rule tables applied by packet processing circuitry 740 with rules to define a traffic destination based on packet type and content. ACC 720 can program table rules (e.g., match-action) into memory accessible to packet processing circuitry 740 based on change in policy and changes in VMs.

For example, ACC 720 can execute a virtual switch such as vSwitch or Open vSwitch (OVS), Stratum, or Vector Packet Processing (VPP) that provides communications between virtual machines executed by host 700 or with other devices connected to a network. For example, ACC 720 can configure packet processing circuitry 740 as to which VM is to receive traffic and what kind of traffic a VM can transmit. For example, packet processing circuitry 740 can execute a virtual switch such as vSwitch or Open vSwitch that provides communications between virtual machines executed by host 700 and packet processing device 710.

MCC 730 can execute a host management control plane, global resource manager, and perform hardware registers configuration. Control plane 732 executed by MCC 730 can perform provisioning and configuration of packet processing circuitry 740. For example, a VM executing on host 700 can utilize packet processing device 710 to receive or transmit packet traffic. MCC 730 can execute boot, power, management, and manageability software (SW) or firmware (FW) code to boot and initialize the packet processing device 710, manage the device power consumption, provide connectivity to Baseboard Management Controller (BMC), and other operations.

One or both control planes of ACC 720 and MCC 730 can define traffic routing table content and network topology applied by packet processing circuitry 740 to select a path of a packet in a network to a next hop or to a destination network-connected device. For example, a VM executing on host 700 can utilize packet processing device 710 to receive or transmit packet traffic.

ACC 720 can execute control plane drivers to communicate with MCC 730. At least to provide a configuration and provisioning interface between control planes 722 and 732, communication interface 725 can provide control-plane-to-control plane communications. Control plane 732 can perform a gatekeeper operation for configuration of shared resources. For example, via communication interface 725, ACC control plane 722 can communicate with control plane 732 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 725 can be utilized by a negotiation protocol and configuration protocol running between ACC control plane 722 and MCC control plane 732. Communication interface 725 can include a general purpose mailbox for different operations performed by packet processing circuitry 740. Examples of operations of packet processing circuitry 740 include issuance of non-volatile memory express (NVMe) reads or writes, issuance of Non-volatile Memory Express over Fabrics (NVMe-oFTM) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others. Communication interface 725 can include one or more mailboxes accessible as registers or memory addresses. For communications from control plane 722 to control plane 732, communications can be written to the one or more mailboxes by control plane drivers 724. For communications from control plane 732 to control plane 722, communications can be written to the one or more mailboxes. Communications written to mailboxes can include descriptors which include message opcode, message error, message parameters, and other information. Communications written to mailboxes can include defined format messages that convey data.

Communication interface 725 can provide communications based on writes or reads to particular memory addresses (e.g., dynamic random access memory (DRAM)), registers, other mailbox that is written-to and read-from to pass commands and data. To provide for secure communications between control planes 722 and 732, registers and memory addresses (and memory address translations) for communications can be available only to be written to or read from by control planes 722 and 732 or cloud service provider (CSP) software executing on ACC 720 and device vendor software, embedded software, or firmware executing on MCC 730. Communication interface 725 can support communications between multiple different compute complexes such as from host 700 to MCC 730, host 700 to ACC 720, MCC 730 to ACC 720, baseboard management controller (BMC) to MCC 730, BMC to ACC 720, or BMC to host 700.

Packet processing circuitry 740 can be implemented using one or more of: application specific integrated circuit (ASIC), field programmable gate array (FPGA), processors executing software, or other circuitry. Control plane 722 and/or 732 can configure packet processing circuitry 740 or other processors to perform operations related to NVMe, NVMe-oF reads or writes, lookaside crypto Engine (LCE), Address Translation Engine (ATE), local area network (LAN), compression/decompression, encryption/decryption, or other accelerated operations. Various message formats can be used to configure ACC 720 or MCC 730. In some examples, a P4 program can be compiled and provided to MCC 730 to configure packet processing circuitry 740.

FIG. 8 depicts a system. In some examples, network interface 850 can be configured as a CDS, as described herein. System 800 includes processor 810, which provides processing, operation management, and execution of instructions for system 800. Processor 810 can include any type of microprocessor, central processing unit (CPU), graphics processing unit (GPU), XPU, processing core, or other processing hardware to provide processing for system 800, or a combination of processors. An XPU can include one or more of: a CPU, a graphics processing unit (GPU), general purpose GPU (GPGPU), and/or other processing units (e.g., accelerators or programmable or fixed function FPGAs). Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, accelerators 842, management controller 844. Interface 812 represents an interface circuit, which can be a standalone component or integrated onto a processor die. Where present, graphics interface 840 interfaces to graphics components for providing a visual display to a user of system 800. In one example, graphics interface 840 can drive a display that provides an output to a user. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a programmable or fixed function offload engine that can be accessed or used by a processor 810. For example, an accelerator among accelerators 842 can provide data compression (DC) capability, cryptography services such as public key encryption (PKE), cipher, hash/authentication capabilities, decryption, or other capabilities or services. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

Applications 834 and/or processes 836 can refer instead or additionally to a virtual machine (VM), container, microservice, thread, service, or other software. Various examples described herein can perform an application composed of microservices, where a microservice runs in its own process and communicates using protocols such as an application program interface (API), a Hypertext Transfer Protocol (HTTP) resource API, a Representational State Transfer (REST) API, message service, remote procedure calls (RPC), or gRPC). Microservices can communicate with one another using a service mesh and be executed in one or more data centers or edge networks. Microservices can be independently deployed using centralized management of these services. The management system may be written in different programming languages and use different data storage technologies. A microservice is a component of a decomposed or distributed service, where the each of the microservices are characterized by one or more of: polyglot programming (e.g., code written in multiple languages to capture additional functionality and efficiency not available in a single language), lightweight container or virtual machine deployment, and decentralized continuous microservice delivery.

In some examples, OS 832 can be Linux® or a Linux distribution (such as openSUSE, RHEL, CentOS, Debian, Ubuntu, Arch, Alpine), Windows® Server or personal computer, a Unix operating system (FreeBSD®, OpenBSD, NetBSD, Solaris, HP-UX, AIX), Android®, MacOS®, iOS®, VMware vSphere, or any other operating system. The OS and driver can execute on a processor sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others. OS 832 or driver can enable or disable use of any accelerators 842, I/O interface 860, network interface 850, peripheral interface 870, or any other accelerator or I/O device.

OS 832 or driver can enable or disable use of network interface device 850 as a CDS. OS 832 or driver can advertise capability of network interface 850 to provide a CDS, as described herein.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, Peripheral Component Interconnect express (PCIe), Compute Express Link (CXL), a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 technology to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. In some examples, packet processing device or network interface device 850 can refer to one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

In one example, system 800 includes one or more input/output (I/O) interface(s) 860. I/O interface 860 can include one or more interface components through which a user interacts with system 800. Peripheral interface 870 can include any hardware interface not specifically mentioned above. Peripherals refer generally to devices that connect dependently to system 800.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. A non-volatile memory (NVM) device is a memory whose state is determinate even if power is interrupted to the device.

In an example, system 800 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), high-speed fabric, NVLink, Advanced Microcontroller Bus Architecture (AMBA) interconnect, OpenCAPI, Gen-Z, Infinity Fabric (IF), InfiniBand, Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Management controller 844, memory 830, and processor 810 can be implemented as part of a same system on chip, same or different chiplets (e.g., integrated circuits), and/or same or different dies (e.g., silicon on which transistors, diodes, resistors, and other components, are housed as part of an electronic circuit). Communications between devices can take place using a network that provides die-to-die communications; chiplet-to-chiplet communications; chip-to-chip communications; circuit board-to-circuit board communications; and/or package-to-package communications.

In an example, system 800 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language. One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: a network interface device comprising: a direct memory access (DMA) circuitry; a network interface; at least two host interfaces to simultaneously connect to multiple platforms; an interface to a memory device; and circuitry, wherein: at least two of the multiple platforms comprise a processor and a memory coupled to a circuit board and the circuitry is to: based on a level of security classification of a second platform of the multiple platforms, perform secure transfer of data from a first platform of the multiple platforms to the second platform of the multiple platforms and enforce rules for data access and data transfer by the multiple platforms.

Example 2 includes one or more examples, wherein the multiple platforms are associated with security domains, security classifications or levels of trust, and associated with isolated domains.

Example 3 includes one or more examples, wherein based on different security classifications of the first and second platforms, the circuitry is to permit transfer of non-confidential data from the first platform to the second platform.

Example 4 includes one or more examples, wherein based on a level of security classification of the second platform being lower than a level of security classification of the first platform, the circuitry is to permit transfer of non-confidential data from the first platform to the second platform.

Example 5 includes one or more examples, wherein the data comprises personal data, healthcare data, automobile data, financial data, or data designated as controlled, regulated, sensitive, confidential, or classified.

Example 6 includes one or more examples, wherein a first region of memory addresses associated with the memory device is allocated to the first platform and a second region of memory addresses associated with the memory device is allocated to the second platform.

Example 7 includes one or more examples, wherein the circuitry comprises a packet processing pipeline configured using a packet processing language includes match-action constructs.

Example 8 includes one or more examples, and includes at least one non-transitory computer-readable medium comprising instructions stored thereon, that if executed by at least one processor, cause the least one processor to: configure a network interface device, comprising: a memory device, a direct memory access (DMA) circuitry, a network interface, and at least two host interfaces to simultaneously connect to multiple platforms, to: based on a configuration, perform a transfer of data from a first platform of the multiple platforms to a second platform of the multiple platforms, wherein the perform a transfer of data from the first platform of the multiple platforms to the second platform of the multiple platforms comprises: write the data to a first region of memory addresses in the memory device assigned solely to the second platform, receive an indication of the write of the data to the first region of memory addresses in the memory device assigned to the second platform, and receive a request to transfer the data, from the first region in the memory device assigned solely to the second platform, to the second platform.

Example 9 includes one or more examples, wherein the multiple platforms are associated with different security domains and the network interface device provides a cross-domain solution (CDS) among the multiple platforms.

Example 10 includes one or more examples, and includes instructions stored thereon, that if executed by at least one processor, cause the least one processor to: based on different security classifications of the first and second platforms, configure the network interface device to permit transfer of non-confidential data from the first platform to the second platform.

Example 11 includes one or more examples, wherein the network interface device comprises one or more of: a network interface controller (NIC), a remote direct memory access (RDMA)-enabled NIC, SmartNIC, router, switch, virtual switch, forwarding element, infrastructure processing unit (IPU), data processing unit (DPU), or edge processing unit (EPU). Example 12 includes one or more examples, wherein a second region of memory addresses associated with the memory device is allocated to the second platform.

Example 13 includes one or more examples, wherein the network interface device comprises a packet processing pipeline configured to provide the a cross-domain solution (CDS) among the multiple platforms based on a packet processing language based on match-action constructs.

Example 14 includes one or more examples, wherein the configuration specifies permitted senders and receivers of data, accessible memory addresses in the memory device, and permitted actions.

Example 15 includes one or more examples, wherein the indication of the write of the data comprises a write to a memory region in the memory device that is to cause the second platform to request transfer of the data from the network interface device to the second platform.

Example 16 includes one or more examples, and includes a method comprising: a network interface device, comprising: a memory device, a direct memory access (DMA) circuitry, a network interface, and at least two host interfaces to simultaneously connect to multiple platforms, performing: based on a configuration, performing a transfer of data from a first platform of the multiple platforms to a second platform of the multiple platforms by: writing the data to a first region of memory addresses in the memory device assigned solely to the second platform and receiving a request to transfer the data, from the first region in the memory device assigned solely to the second platform, to the second platform.

Example 17 includes one or more examples, wherein the multiple platforms are associated with different security domains and the network interface device provides a cross-domain solution (CDS) among the multiple platforms.

Example 18 includes one or more examples, and includes based on different security classifications of the first and second platforms, the network interface device permitting transfer of non-confidential data from the first platform to the second platform.

Example 19 includes one or more examples, wherein the data comprises personal data, healthcare data, automobile data, financial data, or data designated as controlled, regulated, sensitive, confidential, or classified.

Example 20 includes one or more examples, wherein a second region of memory addresses associated with the memory device is allocated to the second platform.

What is claimed is:

1. An apparatus comprising:
a network interface device comprising:
a direct memory access (DMA) circuitry;
a network interface;
at least two host interfaces to simultaneously connect to multiple platforms;
an interface to a memory device; and
circuitry, wherein:
at least two of the multiple platforms comprise a processor and a memory coupled to a circuit board and
the circuitry is to:
based on a level of security classification of a second platform of the multiple platforms, perform secure transfer of data from a first platform of the multiple platforms to the second platform of the multiple platforms and enforce rules for data access and data transfer by the multiple platforms.

2. The apparatus of claim 1, wherein
the multiple platforms are associated with security domains, security classifications or levels of trust, and associated with isolated domains.

3. The apparatus of claim 1, wherein
based on different security classifications of the first and second platforms, the circuitry is to permit transfer of non-confidential data from the first platform to the second platform.

4. The apparatus of claim 1, wherein
based on a level of security classification of the second platform being lower than a level of security classification of the first platform, the circuitry is to permit transfer of non-confidential data from the first platform to the second platform.

5. The apparatus of claim 1, wherein
the data comprises personal data, healthcare data, automobile data, financial data, or data designated as controlled, regulated, sensitive, confidential, or classified.

6. The apparatus of claim 1, wherein
a first region of memory addresses associated with the memory device is allocated to the first platform and
a second region of memory addresses associated with the memory device is allocated to the second platform.

7. The apparatus of claim 1, wherein the circuitry comprises a packet processing pipeline configured using a packet processing language includes match-action constructs.

8. At least one non-transitory computer-readable medium comprising instructions stored thereon, that if executed by at least one processor, cause the least one processor to:
configure a network interface device, comprising: a memory device, a direct memory access (DMA) circuitry, a network interface, and at least two host interfaces to simultaneously connect to multiple platforms, to:
based on a configuration, perform a transfer of data from a first platform of the multiple platforms to a second platform of the multiple platforms, wherein the perform a transfer of data from the first platform of the multiple platforms to the second platform of the multiple platforms comprises:
write the data to a first region of memory addresses in the memory device assigned solely to the second platform,
receive an indication of the write of the data to the first region of memory addresses in the memory device assigned to the second platform, and
receive a request to transfer the data, from the first region in the memory device assigned solely to the second platform, to the second platform.

9. The non-transitory computer-readable medium of claim 8, wherein the multiple platforms are associated with different security domains and the network interface device provides a cross-domain solution (CDS) among the multiple platforms.

10. The non-transitory computer-readable medium of claim 8, comprising instructions stored thereon, that if executed by at least one processor, cause the least one processor to:
based on different security classifications of the first and second platforms, configure the network interface device to permit transfer of non-confidential data from the first platform to the second platform.

11. The non-transitory computer-readable medium of claim 8, wherein the network interface device comprises one or more of: a network interface controller (NIC), a remote direct memory access (RDMA)-enabled NIC, SmartNIC, router, switch, virtual switch, forwarding element, infrastructure processing unit (IPU), data processing unit (DPU), or edge processing unit (EPU).

12. The non-transitory computer-readable medium of claim 8, wherein
a second region of memory addresses associated with the memory device is allocated to the second platform.

13. The non-transitory computer-readable medium of claim 8, wherein the network interface device comprises a packet processing pipeline configured to provide the a cross-domain solution (CDS) among the multiple platforms based on a packet processing language based on match-action constructs.

14. The non-transitory computer-readable medium of claim 8, wherein the configuration specifies permitted senders and receivers of data, accessible memory addresses in the memory device, and permitted actions.

15. The non-transitory computer-readable medium of claim 8, wherein the indication of the write of the data comprises a write to a memory region in the memory device that is to cause the second platform to request transfer of the data from the network interface device to the second platform.

16. A method comprising:
a network interface device, comprising: a memory device, a direct memory access (DMA) circuitry, a network interface, and at least two host interfaces to simultaneously connect to multiple platforms, performing:
based on a configuration, performing a transfer of data from a first platform of the multiple platforms to a second platform of the multiple platforms by:
writing the data to a first region of memory addresses in the memory device assigned solely to the second platform and
receiving a request to transfer the data, from the first region in the memory device assigned solely to the second platform, to the second platform.

17. The method of claim 16, wherein the multiple platforms are associated with different security domains and the network interface device provides a cross-domain solution (CDS) among the multiple platforms.

18. The method of claim 16, comprising:
based on different security classifications of the first and second platforms, the network interface device permitting transfer of non-confidential data from the first platform to the second platform.

19. The method of claim 16, wherein the data comprises personal data, healthcare data, automobile data, financial data, or data designated as controlled, regulated, sensitive, confidential, or classified.

20. The method of claim 16, wherein
a second region of memory addresses associated with the memory device is allocated to the second platform.
